(19) United States
(12) Patent Application Publication
(10) Pub. No.: US 2010/0050234 A1
(43) Pub. Date: Feb. 25, 2010

(54) Provision of Access Information in a Communication Network

(76) Inventors: Fredrik Lindholm, Alvsjo (SE); Maria Esther Terrero Dlaz-Chirón, Madrid (ES); Nuria Esteban Vares, Madrid (ES)

Correspondence Address: ERICSSON INC., 6300 LEGACY DRIVE, M/S EVR 1-C-11, PLANO, TX, 75024, US

(21) Appl. No.: 12/443,832

(22) PCT Filed: Oct. 3, 2006
(86) PCT No.: PCT/EP06/67011

§ 371 Date: Oct. 28, 2009

(51) Int. Cl. H04L 29/06; G06F 7/04

(52) U.S. Cl. 726/3

(57) ABSTRACT

A method and apparatus for providing user access information to a Home Subscriber Server (HSS) in an IP Multimedia Subsystem (IMS) network. A User Equipment transmits to a Call Session Control Function (CSCF), a message containing a P-Access-Network-Info (PANI) header. The CSCF or an Application Server then sends user access information retrieved from the PANI header to the HSS, which stores the information. The stored information can be used to control access to the IMS network based on the access network being utilized or the user location.

### FIELD OF THE INVENTION

The present invention relates to provision of access information in an IP Multimedia Subsystem network.

### BACKGROUND OF THE INVENTION

IP Multimedia services provide a dynamic combination of voice, video, messaging, data, etc. within the same session. By growing the number of basic applications and the media which it is possible to combine, the number of services offered to the end users will grow, and the inter-personal communication experience will be enriched. This will lead to a new generation of personalised, rich multimedia communication services, including so-called “combinational IP Multimedia” services which are considered in more detail below.

IP Multimedia Subsystem (IMS) is the technology defined by the Third Generation Partnership Project (3GPP) to provide IP Multimedia services over mobile communication networks (3GPP TS 22.228, TS 23.218, TS 23.228, TS 24.228, TS 24.229, TS 29.228, TS 29.229, TS 29.328 and TS 29.329 Releases 5 to 7). IMS provides key features to enrich the end-user person-to-person communication experience through the use of standardised IMS Service Enablers, which facilitate new rich person-to-person (client-to-client) communication services as well as person-to-content (client-to-server) services over IP-based networks. The IMS makes use of the Session Initiation Protocol (SIP) to set up and control calls or sessions between user terminals (or user terminals and application servers). The Session Description Protocol (SDP), carried by SIP signalling, is used to describe and negotiate the media components of the session. Whilst SIP was created as a user-to-user protocol, IMS allows operators and service providers to control user access to services and to charge users accordingly.

FIG. 1 illustrates schematically how the IMS fits into the mobile network architecture in the case of a General Packet Radio Service (GPRS)/Packet Switched (PS) access network. Call Session Control Functions (CSCFS) operate as SIP proxies within the IMS. The 3GPP architecture defines three types of CSCFs: the Proxy CSCF (P-CSCF) which is the first point of contact within the IMS for a SIP terminal; the Serving CSCF (S-CSCF) which provides services to the user that the user is subscribed to; and the Interrogating CSCF (I-CSCF) whose role is to identify the correct S-CSCF and to forward to that S-CSCF a request received from a SIP terminal via a P-CSCF. Of course, the IMS may be accessed from other access network types, for example a Wireless Local Area Network (WLAN) network.

In some circumstances, it is desirable to provide user access information, which includes information about the technology used to access the network, and the location of the user, to a Home Subscriber Server (HSS). An example of this is where access control depends on the Access Point (AP) used to access the network. An AP may be a base station of a WLAN or a Node B of 3GPP cellular network. It may be desirable to allow operators of IMS networks to control which APs may be used to access their networks. For example, a network operator may have negotiated a special tariff with a company that depends upon the company's employees accessing the operator's IMS network only via APs of the network operator. In order to control access to a network depending on the AP used, access information must be stored in the user's profile at the HSS.

Another example of a scenario where it is desirable to provide access information to a HSS arises from Fixed Mobile Convergence (FMC). A user having a subscription to an IMS network may have multiple user identities, some of which may be used to access a network using a fixed line service and some of which may be used to access a network using a mobile service. The capabilities of the fixed and mobile services may differ, and so user access information is required to be stored on the user's profile to show what sort of access network or AP was used to access the IMS network. This will allow available services to be determined depending on the user's profile and the capabilities of the AP or the access network.

Mechanisms are available for providing access information to the HSS. One such method is for User Equipment to obtain the Media Access Control (MAC) address of the AP and include this in a SIP REGISTER message. The MAC address can then be used to identify the user's location to the HSS. However, this approach requires signalling in addition to sending a SIP REGISTER message in order to obtain the MAC address of the AP.

### SUMMARY OF THE INVENTION

When a user accesses an IP Multimedia Subsystem network, the User Equipment (UE) includes a P-Access-Network-Info (PANI) header in each message sent during a registration procedure, for example a SIP REGISTER message (see ETSI ES 283 003 V1.1.1). The PANI header is a 3GPP-defined header and indicates to the IMS network over which access technology the UE is attached to the IMS, and also the location of the user. Presently, the PANI may be sent from the UE to a Call Session Control Function (CSCF), or alternately, for some access, the Proxy CSCF adds the location based on local knowledge.

The inventors of the present invention have realised that by forwarding access information from the PANI, or the entire contents of the PANI itself, to the Home Subscriber Server, a persistent record of the access information for a session can be stored in the user profile, and this information can be used to control access to the network depending on the access information, or to determine the services available to the user based on the capabilities of the access network technology and location used (referred to as access information).

According to a first aspect of the present invention, there is provided a method of providing access information to a Home Subscriber Server in an IP Multimedia Subsystem, the method comprising:
transmitting a message from User Equipment to a Call Session Control Function, the message including a P-Access-Network-Info header;
transmitting access information contained in the P-Access-Network-Info header from the Call Session Control Function or Application Server to a Home Subscriber Server; and
at the Home Subscriber Server, storing the received access information.

It is preferred that the message is a SIP REGISTER message.

In a preferred embodiment of the invention, the method further comprises verifying the P-Access-Network-Info header or the access information obtained therefrom. The verifying step may comprise comparing the P-Access-Network-Info header or the access information obtained therefrom with a range of the P-Access-Network-Info headers that may be used by the Call Session Control Function. Alternatively, the verifying step may comprise obtaining location information from a mobile location register function and comparing the obtained location information with access information obtained from the P-Access-Network-Info header.

There is also provided a method of controlling access to services of an IP Multimedia Subsystem by a user, based upon the user's location, the method comprising:
providing access information to a Home Subscriber Server using the method described above;
comparing location information obtained from the access information with authorisation information stored on a database, the authorisation information comprising information identifying prohibited and/or allowed access locations for the user; and
dependent upon the result of the comparison, allowing or denying access to the IP Multimedia Subsystem services.

In addition, there is provided a method of determining services available to a user from an Application Server based upon the user's access information, the method comprising:
providing access information to a Home Subscriber Server using the method described above;
transmitting the access information from the Home Subscriber Server to the Application Server; and
comparing the access information with the available services and, on the basis of the comparison, determining which services to make available to the user.

Furthermore, there is provided a method of filtering a user profile in an IP Multimedia Subsystem network based upon the user's access information, the method comprising:
providing access information to a Home Subscriber Server using the method described above;
at the Home Subscriber Server, filtering the user profile based upon the access information.

There is provided a method of providing a user profile to a Call Session Control Function comprising:
filtering the user profile using the method described above; and
delivering the filtered user profile to the Call Session Control Function.

According to a second aspect of the present invention, there is provided a Call Session Control Function for use in an IP Multimedia Subsystem comprising:
input means for receiving a message sent from User Equipment, the message comprising a P-Access-Network-Info header; and
output means for sending to a Home Subscriber Server part or all of the contents of the P-Access-Network-Info header.

According to a third aspect of the present invention, there is provided a Home Subscriber Server for use in an IP Multimedia Subsystem comprising:
input means for receiving part or all of the contents of a P-Access-Network-Info header; and
storage means for storing said contents of the P-Access-Network-Info header.

It is preferred that the Home Subscriber Server further comprises means to update a user profile with the received contents.

According to a fourth aspect of the present invention, there is provided an Application Server for use in an IP Multimedia Subsystem comprising:
input means for receiving a message sent from User Equipment, the message comprising a P-Access-Network-Info header; and
output means for sending to a Home Subscriber Server part or all of the contents of the P-Access-Network-Info header.

### BRIEF DESCRIPTION OF THE DRAWINGS

FIG. 1 illustrates schematically an IP Multimedia Subsystem;

FIG. 2 illustrates a signalling sequence for attempted registration from a non-allowed Access Point;

FIG. 3 illustrates a signalling sequence for obtaining access information from a Home Subscriber Server;

FIG. 4 illustrates a signalling sequence for notifying a Call Session Control Function of the user's access information; and

FIG. 5 illustrates schematically a known example of a set of IP Multimedia Private and Public User Identities associated with an IP Multimedia Subsystem subscription.

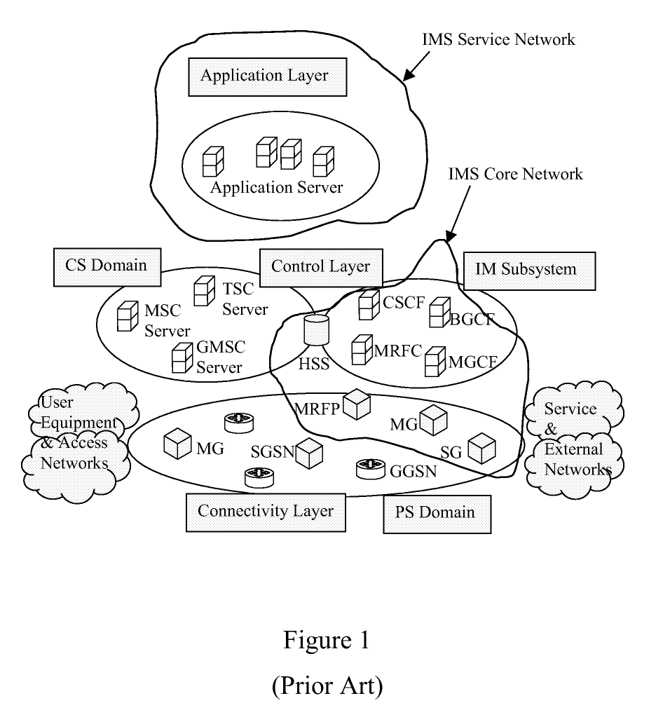

### DETAILED DESCRIPTION OF THE PREFERRED EMBODIMENTS

As described above, a P-Access-Network-Info (PANI) header may be generated at the user's User Equipment (UE) and incorporated in each message sent by the UE, or alternatively the PANI header is added to a message by the Proxy-CSCF (P-CSCF). The information contained in the PANI header is shown in Table 1. The PANI header includes information identifying the type of access network (e.g. 3GPP-UTRAN-FDD, 3GPP-GERAN, ADSL etc.) over which the UE is attached to the IMS network, and the location of the user.

In the case where the UE accesses the IMS network via a wireless access network and a Proxy-Call Session Control Function compliant with 3GPP Release 6 specifications, the PANI header is not verified. The IMS network assumes that the UE has inserted the correct access information in the PANI header. On the other hand, where UE accesses the IMS network via a fixed line network, the P-CSCF verifies that the information contained in the PANI header is correct, and if not, replaces the PANI header with the correct PANI header.

When a user attempts to access an IMS network, the UE sends a SIP REGISTER message to the P-CSCF. The SIP REGISTER message includes a PANI header. The P-CSCF, instead of removing the PANI header, allows it to be forwarded to the Interrogating-Call Session Control Function (I-CSCF) within the REGISTER message. In the present invention, the I-CSCF then sends a User Authorisation Request (UAR) message to the Home Subscriber Server (HSS), and includes either the PANI or access information obtained from the PANI in the UAR message.

A UAR message is a standard message sent from the I-CSCF to the HSS that, among other things, requests authorisation for the user. The Augmented Backus-Naur Form (ABNF) command codes for sending this information are as follows, where the “Access-Information” is the new information element:

Message Format
< User-Authorisation-Request> ::= < Diameter Header: 300, REQ, PXY,
16777216 >

< Session-Id >
{ Vendor-Specific-Application-Id }
{ Auth-Session-State }
{ Origin-Host }
{ Origin-Realm }
[ Destination-Host ]
{ Destination-Realm }
{ User-Name }
*[ Supported-Features ]
{ Public-Identity }
{ Visited-Network-Identifier }
[ User-Authorisation-Type ]
[Access-Information]
*[ AVP ]
*[ Proxy-Info ]

Similarly, other Diameter message exchanges between a S-CSCF and the HSS, and between an Application Server (AS) and the HSS can be extended to include the access information.

As described above, where a user attempts to register via a mobile access network, the PANI header may not be verified before being sent to the HSS. In this case, logic to verify the PANI header is provided to verify the PANI header at the I-CSCF, Serving-CSCF (S-CSCF) or Application Server (AS) that sends the PANI header to the HSS. This logic may be performed by checking if the PANI header can be trusted by checking the P-CSCF used against a configured list. If the PANI header is not trusted, the logic either checks whether the PANI header is within a set of PANI headers that may be used by the P-CSCF, or checks with the mobile location register function and compares the location contained in the PANI header with the location given by the mobile location register function.

Once the PANI header has been received by the HSS, the HSS can store access information in the user profile relating to the access location or access technology used to access the network.

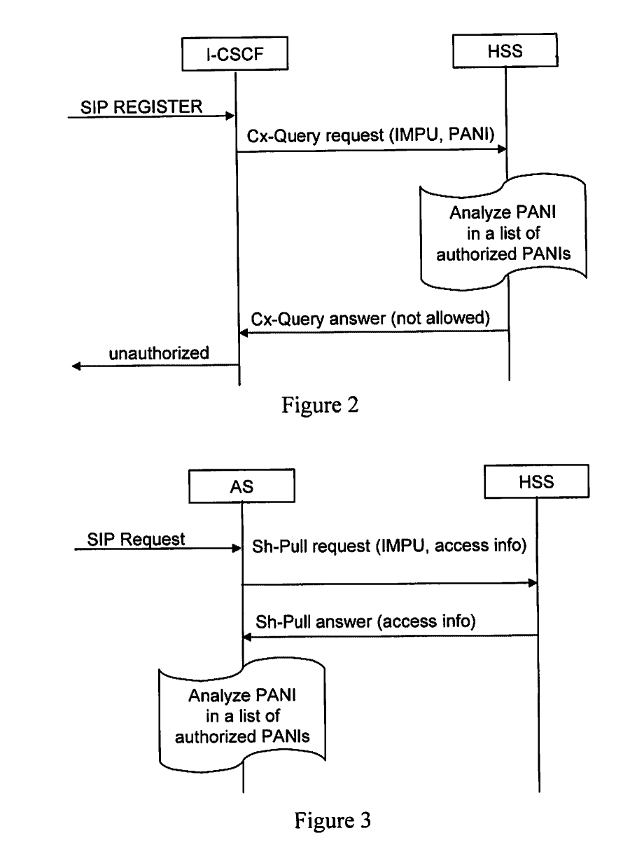

Access information can be used to check whether the user is allowed to register with the IMS network from the access network used. Referring to FIG. 2, access authorisation is controlled by the I-CSCF and the HSS. The I-CSCF receives a SIP REGISTER message from User Equipment, the SIP REGISTER message including a PANI header. The I-CSCF sends a Cx-Query request (UAR) containing the PANI header and the user's IP Multimedia Public Identity (IMPU) to the HSS. The HSS compares the PANI received with a stored list of authorised PANIs, and makes a decision on whether or not to allow access based on that comparison. The HSS can control authorisation based on different parameters. For example, the user can be authorised to access the network from one of a plurality of different locations.

By authorising the user via the I-CSCF, certain users, for example those that use only weak authentication methods, can be prevented from accessing the core IMS network. As an example, access can be limited to only access requests that are highly trusted.

In addition, the HSS can dynamically define the Server-Capabilities for S-CSCF selection based on the access used and identified in the PANI.

Another use for the stored access information is in allowing an Application Server (AS) to retrieve user information from the HSS that may be relevant for a particular access. This can allow an AS to tailor the service to a user on the basis of the access information. Referring to FIG. 3, the AS receives a SIP INVITE from the UE to access a particular service. The AS sends a Sh-pull message to the HSS. The Sh-pull request includes a value of the Data-Reference AVP for requesting access information stored in the user's profile at the HSS. The HSS receives the Sh-pull message and retrieves the required access information. The access information is included with the Sh-pull answer sent from the HSS to the AS.

Another use of this invention is that the AS can tailor the service provided to the user depending on the access information received. The AS can provide the user access information in a query to the HSS, and the HSS responds with a customized profile for that user based on the user's access information. For example, the access technology used to access the network may place limitations on the type of data that can be included in the service.

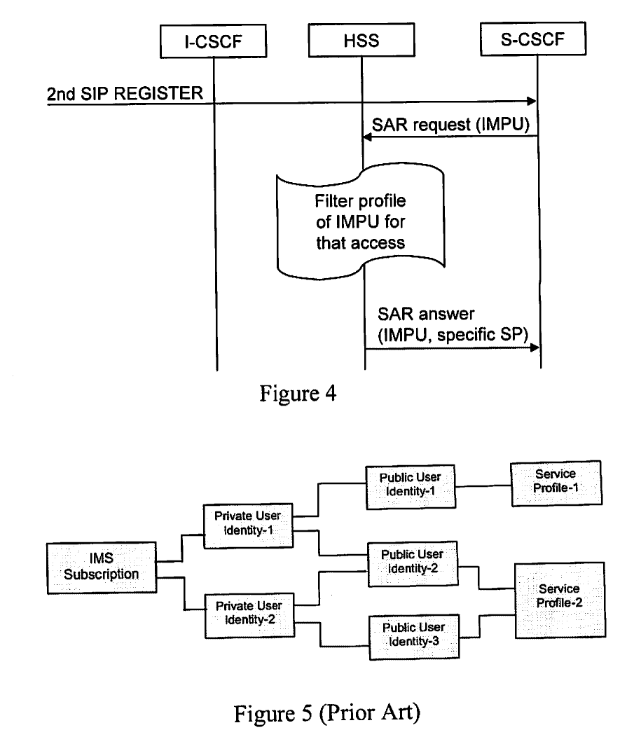

The stored access information can also be used by the HSS to filter the profile required by a user for a given access. For example, if a user registers for a service from a fixed line access, parts of the service that are relevant only to mobile access may be omitted in the profile download. This increases the efficiency of service triggering procedures in the S-CSCF, as the number of triggers that must be evaluated by the S-CSCF are reduced. Other information can be included in the profile, such as time of day and authentication method, in addition to the access information. Referring to FIG. 4, a UE sends a SIP REGISTER message to a S-CSCF. The S-CSCF sends a Server Assignment Request (SAR) to the HSS, the SAR containing the user's IP Multimedia Public Identities (IMPU). The HSS filters the profile of the IMPU for that access and returns a SAR answer to the S-CSCF containing a Service profile (SP), including Initial Filter Criteria triggers. S-CSCF uses the SP to tailor the service.

Persistent storage of access information in a user's profile at the HSS can also be used to support multiple identity handling. Referring to FIG. 5, there is illustrated schematically a known example of a set of IP Multimedia Private and Public User Identities associated with an IP Multimedia Subsystem subscription. In this example, a user having an IMS subscription has two IP Multimedia Private Identities (IMPIs), IMPI-1 and IMPI-2. IMPI-1 has two IP Multimedia Public User Identities (IMPUs), IMPU-1 and IMPU-2, associated with it. IMPI-2 has one IMPU, IMPU-3 associated with it. IMPU-1 is associated with a first service profile, whereas IMPU-2 and IMPU-3 are each associated with a second service profile. In this example, IMPU-2 can be accessed simultaneously by fixed line access and a mobile access. By providing the HSS with access information, the network is made aware of the access technology used to access the network. This allows, for example, use of different authentication methods for each IMPU, depending on the access information provided to the HSS.

It will be appreciated by persons skilled in the art that various modifications may be made to the embodiments described above without departing from the scope of the present invention.

TABLE 1

| | |
|---|---|
| P-Access-Network-Info = | “P-Access-Network-Info” HCOLON |
| | access-net-spec *(COMMA access-net-spec) |
| access-net-spec = | access-type *(SEMI access-info) |
| access-type = | “IEEE-802.11” / ″IEEE-802.11a″ / ″IEEE- |

802.11b″ / ″IEEE-802.11g″ / ″3GPP-GERAN″ /
″3GPP-UTRAN-FDD″ / ″3GPP-UTRAN-TDD″ / ″ADSL″ /
″ADSL2″ / ″ADSL2+″ / ″RADSL″ / ″SDSL″ / ″HDSL″ /
″HDSL2″ / ″G.SHDSL″ / ″VDSL″ / ″IDSL″ / ″3GPP2-
1X″ / ″3GPP2-1X-HRPD″ /token

| | |
|---|---|
| access-info = | cgi-3gpp / utran-cell-id-3gpp / dsl- |

location / np / ci-3gpp2/ extension- access-info

| | |
|---|---|
| extension-access-info = | gen-value |
| cgi-3gpp = | ″cgi-3gpp″ EQUAL (token / quoted-string) |
| utran-cell-id-3gpp = | ″utran-cell-id-3gpp″ EQUAL (token / |

quoted-string)

| | |
|---|---|
| dsl-location = | ″dsl-location″ EQUAL (token / quoted- |

string)

| | |
|---|---|
| np = | ″network-provided″ |
| ci-3gpp2 = | ″ci-3gpp2″ EQUAL (token / quoted-string) |

1. A method of controlling access to services of an IP Multimedia Subsystem network based upon a user's location, the method comprising:
transmitting a message from a User Equipment to an Interrogating-Call Session Control Function (I-CSCF), the message including a P-Access-Network-Info (PANI) header;
transmitting access information comprising location information contained in the PANI header from the I-CSCF to a Home Subscriber Server (HSS);
storing the received access information at the HSS;
comparing by the HSS, the received location information obtained from the access information with authorization information stored at a database, the authorization information identifying prohibited or allowed access locations for the user; and
dependent upon the results of the comparison, denying or allowing access to the IP Multimedia Subsystem network.

2. The method according to claim 1, wherein the message is a SIP REGISTER message.

3. The method according to claim 1m comprising verifying the PANI header or the access information obtained therefrom.

4. The method according to claim 3, wherein the verifying step comprises comparing the PANI header or the access information obtained therefrom with a range of the PANI headers that may be used by the I-CSCF.

5. The method according to claim 3, wherein the verifying step comprises obtaining location information from a mobile location register function and comparing the obtained location information with access information obtained from the PANI header.

6. The method according to claim 1, the method further comprising:
transmitting the access information from the HSS to an Application Server; and
comparing the access information with available services and, on the basis of the comparison, determining which services to make available to the user.

7. The method according to claim 1, the method further comprising, at the HSS, filtering a user profile based upon the access information.

8. The method according to claim 7, further comprising delivering the filtered user profile to the I-CSCF.

9. An Interrogating-Call Session Control Function for use in an IP Multimedia Subsystem comprising:
input means for receiving a message sent from a User Equipment, the message comprising a P-Access-Network-Info (PANI) header; and
output means for sending to a Home Subscriber Server part or all of the contents of the PANI header.

10. A Home Subscriber Server for use in an IP Multimedia Subsystem network comprising:
input means for receiving part or all of the contents of a P-Access-Network-Info (PANI) header sent from an Interrogating-Call Session Control Function;
storage means for storing the contents of the PANI header;
comparing means for comparing location information contained in the access information with authorization information stored at a database, the authorization information identifying prohibited or allowed access locations for the user.

11. The Home Subscriber Server according to claim 10, further comprising means for updating a user profile with the received contents.
